(19) United States
(12) Patent Application Publication
(10) Pub. No.: US 2006/0282534 A1
(43) Pub. Date: Dec. 14, 2006

(54) Application error dampening of dynamic request distribution

(75) Inventor: Douglas Charles Berg, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 11/149,487

(22) Filed: Jun. 9, 2005

(51) Int. Cl. G06F 15/173

(52) U.S. Cl. 709/225; 709/226

(57) ABSTRACT

An apparatus and method provide efficient dynamic request distribution among a plurality of resources when a resource in the plurality of resources returns an abnormal rate of exceptions. A dynamic request distributor monitors exception rates by resource in the plurality of resources resulting from requests made to the resources in the plurality of resources. If a particular resource returns exceptions at an abnormally high rate, the dynamic request distributor responds by routing relatively fewer subsequent requests to that particular resource.

### BACKGROUND OF THE INVENTION

1. Field of the Invention

The current invention generally relates to computer systems. More particularly, the current invention relates to computer systems where an application or applications make requests to pools of resources. If a particular resource in the pool of resources returns an abnormally high rate of exceptions a dynamic workload distributor sends relatively fewer requests to that particular resource.

1. Description of the Related Art

Modern computing systems frequently have one or more applications running in a client system or systems. The applications make requests to server systems. For example, a client may request a web page to be provided by a server. The particular server could be one of a plurality of server computer systems capable of finding the web page and routing the web page back to the client, thereby satisfying the request. Some computing systems employ dynamic request distributors to route requests to one particular server instead of other servers in the plurality of servers based on knowledge of the performance capabilities of the particular server, the measured response time of the particular server, or the number of outstanding requests in a queue of the particular server, all versus the same considerations of the other servers in the plurality of servers.

For example, the dynamic request distributor might send twice as many requests to a first server as to a second server if the dynamic request distributor knows that the first server is twice as fast (e.g., because of clock frequency, memory capacity, link speed, etc) as the second server. A non-computer example of this method would be that a shopper in a grocery store might prefer to go to a checkout line where the shopper knows that the cashier is very efficient.

The dynamic request distributor might, alternatively, send out many more requests to the first server as to a second server if an average response is, on average, twice as fast from the first server. For example, the shopper might favor lines that they notice are “moving faster.

In another method the dynamic request distributor may use is to keep track of the number of outstanding requests for each server, and simply make new requests to a particular server having a smallest number of outstanding requests, similar to the shopper in a grocery store choosing the shortest checkout line.

In general, the dynamic request distribution methods described above work well. However, a problem arises when a server develops a problem that results in an abnormal number of exceptions. An exception is a response by a resource that doesn't satisfy the request. For example, if the request is to an internet server for a web page but the web page cannot be found, an exception is returned. If the internet server is having trouble communicating on the internet, an exception is returned. Many exceptions tend to take very little time on the part of the server, and therefore exceptions are returned quickly relative to the length of time the server typically takes for non-exception responses. Returning to the grocery store example, if a customer approaches a cashier with a handful of bananas, but the cashier's scale is broken, the cashier simply (and quickly) tells the customer that he can not handle the request to make the sale. In the examples above, this situation would trick or deceive any of the dynamic request distribution methods into directing more and more requests to the server experiencing problems. A cashier having a faulty weight scale will quickly tell many shoppers to get their bananas rung up elsewhere. An observer would measure a very fast response time in the checkout line experiencing the problem. And, finally, the checkout line at the faulty scale will be short because requesters (shoppers) are being quickly told to leave.

The above deception of a dynamic request distributor by exceptions is often referred to as a “storm drain” problem, where the dynamic request distributor directs more and more requests to a problematic server; the problematic server returning a relatively high proportion of exceptions, rather than desired responses to the requests.

Although “client”, “server”, “shopper”, “computer”, “cashier” are used in this specification for explanatory purposes, it will be understood that what is broadly meant is a system having a “requestor”(e.g., computer, client, application program, shopper, etc) and a “resource”(e.g., computer, server, hard disk in a computer system, communications path in a computer system or between computer systems, cashier, etc).

Therefore, there is a need for a method and apparatus that provide for more efficient dynamic request distribution.

### SUMMARY OF THE INVENTION

The current invention teaches methods and apparatus that provide for efficient distribution of requests from a requestor among a plurality of resources capable of handling the requests, and accommodates problems in a particular resource by routing fewer requests to that particular resource.

A dynamic request distributor routes each request to one of the resources in the plurality of resources. The dynamic request distributor observes exceptions from each resource and, if a rate of exceptions from a particular resource is abnormally high, the dynamic request distributor routes relatively fewer requests to that particular resource.

The rate of exceptions from the particular resource is identified as abnormally high if the rate of exceptions from the particular resource is high compared to an exception rate specified by an authority, or is high compared to other resources in the plurality of resources.

Considered as a method, requests from a requester are routed to a plurality of resources, each resource capable of handling the requests. The method includes the steps of observing a rate of exceptions returned from a resource in the plurality of resources; identifying the resource as a problem resource if the rate of exceptions returned by that resource is abnormally high; and routing fewer requests to the problem resource for subsequent requests.

### BRIEF DESCRIPTION OF THE DRAWINGS

FIG. 1 is a block diagram of a computer network.

FIG. 2 shows a block diagram of a dynamic request distributor suitable for routing requests to one of a plurality of resources.

FIG. 3A is a chart showing outstanding request and exception data for each of three resources.

FIG. 3B is a prior art graph of routing probability versus number of outstanding requests on a particular resource.

FIG. 3C is a prior art graph of percent of requests sent to a resource versus a weighted exception rate.

FIG. 3D is a graph of routing probability versus a weighted exception rate according to teachings of the present invention.

FIG. 3E is a graph of percent of requests sent to a resource versus a weighted exception rate according to teachings of the present invention.

FIG. 3F is a bar chart showing how, for a particular resource returning an abnormally high rate of exceptions, receives, over time, a lower rate of requests from the dynamic request distributor.

FIG. 4 is a more detailed block diagram of the dynamic request distributor.

FIG. 5A is a bar chart showing relative performance and relative exception rate for three resources.

FIG. 5B show an exemplary resource list suitable to support a dynamic request distributor that considers the relative resource capability versus relative exception rate as shown in FIG. 5A.

FIG. 6 is a flow chart illustrating a method embodiment of the invention.

### DETAILED DESCRIPTION OF THE PREFERRED EMBODIMENTS

The invention will be described in detail with reference to the figures. It will be appreciated that this description and these figures are for illustrative purposes only, and are not intended to limit the scope of the invention. In particular, various descriptions and illustrations of the applicability, use, and advantages of the invention are exemplary only, and do not define the scope of the invention. Accordingly, all questions of scope must be resolved only from claims set forth elsewhere in this disclosure.

The current invention teaches a method and apparatus to efficiently route requests from a requestor to various resources in a plurality of resources. If a particular resource responds with exceptions at an unexpectedly high rate, fewer requests are routed to that particular resource.

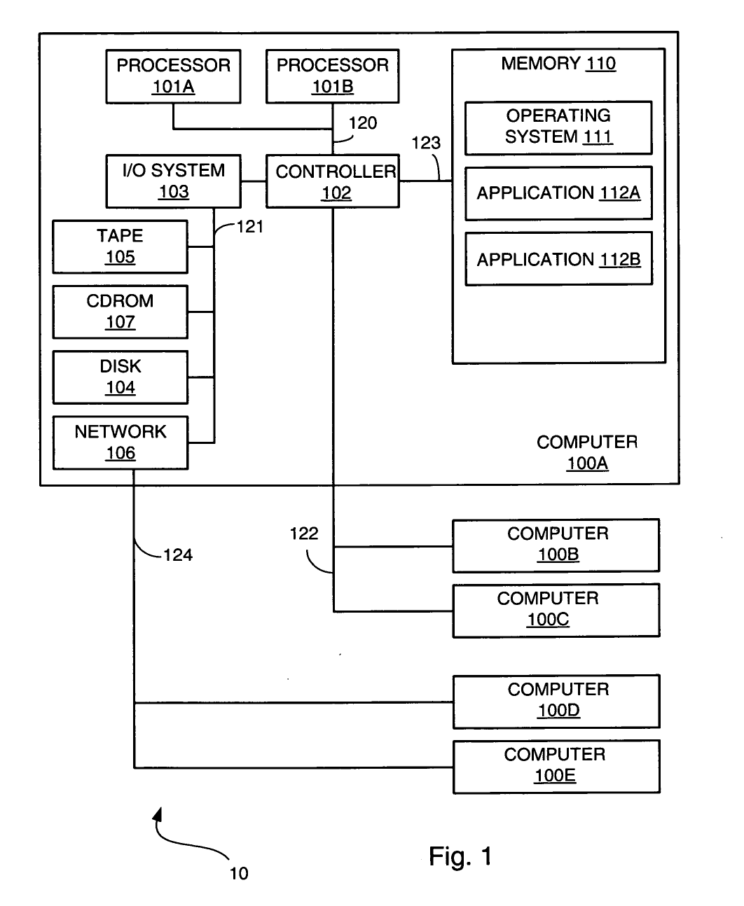

FIG. 1 is a block diagram of a computer network 10 comprising computers 100A-100E. A computer will generally be referred to as computer 100 unless a particular computer is being discussed. Computer 100A is shown to contain processors 101A, 100B. Any number of processors in a computer is contemplated. Processors 101A, 101B are coupled by a processor bus 120 to a controller 102. Controller 102 is further coupled to a memory 110 and an I/O (input/output) controller system 103. Controller 102 can also provide a high speed coupling to other computers, computers 100B, 100C, as shown over a signaling bus 122. Many modern computing systems comprise computer nodes coupled by busses. A computing system comprising computers 100A, 100B, 100C would be an example of such a system.

I/O controller system 103 provides for control of various I/O devices, such as tape 105, CDROM 107, disk 104, and network 106. Tape 105 is one or more magnetic tape devices capable of reading and writing data to magnetic tape. CDROM 107 is one or more devices that are capable of reading and/or writing data to a CDROM. Disk 104 is one or more magnetic disks. Network 106 is capable of sending and receiving data over a network, such as a LAN (Local Area Network), a WAN (Wide Area Network), or the internet. Network 106 is shown coupling computer 100A to computers 100D, 100E via coupling 124. In various implementations, coupling 124 is an Ethernet cable, a wireless communication system, a telephone line, or any other mechanism capable of coupling a first computer to a second computer.

Memory 110 contains an operating system 111 and one or more applications 112, shown as applications 112A and 112B. It will be understood that memory 110 may be implemented as a memory hierarchy containing multiple levels of cache, and that portions of operating system 111 and applications 112A, 112B may, at a given point in time, not be fully held in any one level of the memory hierarchy. Operating system 111 generally manages operation of computer 100A, controlling launching of applications, providing authority of applications to access data in memory 110 (as well as data on disks, and other data storage devices), and many other computer management functions. Applications 112A, 112B are requestors that make requests for data, the requests serviceable by any of a plurality of resources in computer network 10. For example, application 112A may make a request for a database query. It may be that any of the computers 100A-100E is capable of handling the request of the database query, and computer networks have mechanisms described below to direct the query to a resource.

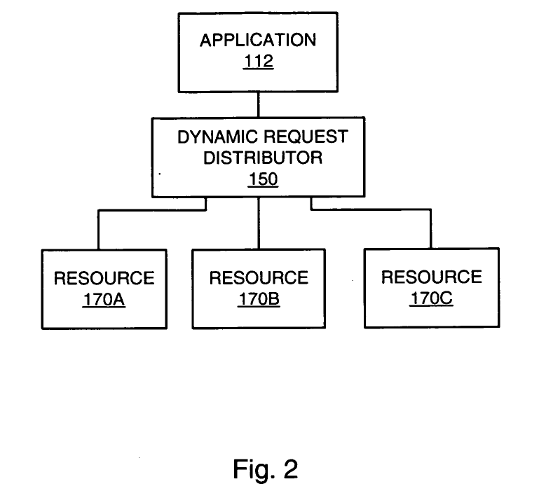

FIG. 2 shows a general application 112 (e.g., application 112A, 112B in computer 100A) in communication with a dynamic request distributor 150. Dynamic request distributor 150, in an embodiment, is a computer program resident in memory 110 and executing on a processor 101, e.g., 101A, or 101B. In another embodiment, dynamic request distributor 150 is designed into controller 102. Dynamic request distributor 150 receives a request from application 112, and chooses a particular resource from a plurality of resources capable of satisfying the request by routing the request to, in the exemplary drawing shown in FIG. 2, resource 170A, 170B, or 170C.

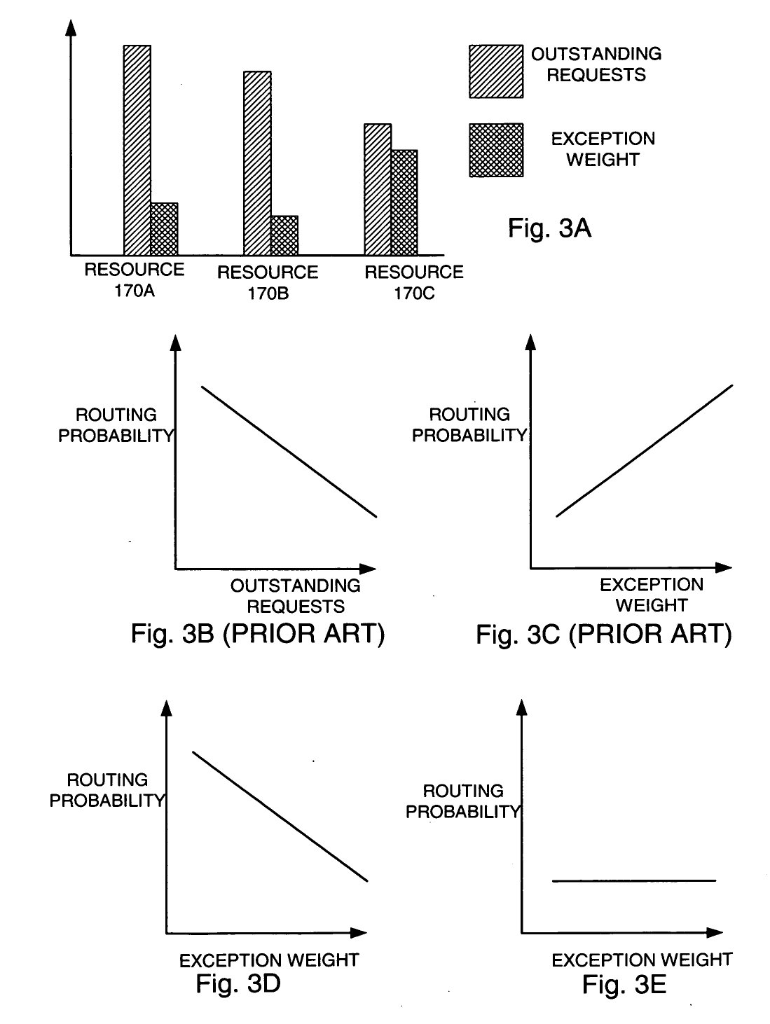

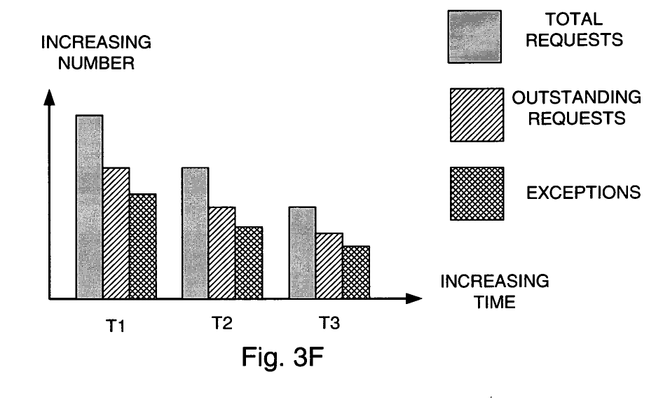

FIG. 3A is a bar graph showing, for three resources (170A, 170B, 170C, introduced in FIG. 2) a number of outstanding requests for each resource, and the rate of exceptions for each resource. Exceptions are typically expressed as a rate of exceptions, such as the number of exceptions returned for a particular number of requests, or, alternatively a number of exceptions returned over a specified period of time. For example, 10 exceptions returned during the last 1000 requests, or 10 exceptions returned over the past second of time.

As described earlier, many conventional dynamic request distributors typically send a new request to a shortest queue (fewest outstanding request), a resource known a priori as a fastest resource, or to the resource that is handling requests fastest over a recent period of observation. Assuming outstanding request counts as shown in FIG. 3A for resources 170A, 170B, 170C, a conventional dynamic request distributor would direct requests with a probability, or frequency, as shown in FIG. 3B. Resource 170C clearly has the shortest queue (fewest outstanding requests). A conventional dynamic request distributor executing a method of preferentially sending requests to resources with shorter queues will send requests to resource 170C more often than to resource 170A or 170B. Resource C, however, is returning an abnormally high rate of exceptions, and has an abnormally high exception weight (defined below), as shown in FIG. 3A.

A high rate of exceptions, by itself, does not necessarily mean an abnormally high rate of exceptions. For example, a very high speed resource, handling more requests, would be expected to return more exceptions. Therefore, calculating an exception weight helps in determining, using one of several techniques described below, when an exception rate is abnormally high, relative to a performance of a resource, versus one or more other resources, versus an average exception rate among all resources, or simply versus a target exception rate specified by an authority. An abnormal exception weight therefore identifies an abnormal exception rate. An authority, such as a computer operator, a computer administrator, or a designer of an application specifies, for each of the above comparisons, what constitutes an abnormal exception rate. For example, an exception weight that compares a first resource to a second resource shows that the first resource returns twice as many exceptions per request. The authority specifies that this is an abnormally high exception weight and therefore the exception rate of the first resource is abnormally high. For a second example, if an application has generated total 10,000 requests during a time interval, and found that an total exception rate is 20%, but that a particular resource is has an exception rate of 60%, an exception weight calculated as a resource's exception rate divided by the total exception rate, quickly identifies the particular resource as having an abnormally high exception weight, and therefore an abnormally high exception rate, even though the total exception rate (i.e., 20%) is relatively high.

In an embodiment, an exception weight is calculated as the ratio of exceptions returned for a given number of requests to the number of requests. For example, the number of exceptions returned responsive to the last 1000 requests handled. As shown in prior art FIG. 3C a conventional dynamic request distributor routes a larger number of requests to a problem resource as the value of the exception weight increase.

A second conventional dynamic request distributor that uses a priori knowledge of resource performance sends three times as many requests to resource 170C as to resource 170A, using the exemplary performance characteristics of resources 170A-170C given above. However, many/most of the requests returned by resource 170C are merely exceptions, rather than substantive responses needed by the requestor.

A third conventional dynamic request distributor that observes how fast requests flow through queues of resources and routes more requests to resources for which requests quickly flow through their input queues will likewise be fooled into directing a large number of requests to resources having a high exception weight, as such resources will be handling resources quickly, but responding with a high percentage of exceptions.

Embodiments of the invention produce a routing probability versus exception weight as generally shown in FIG. 3D. That is, as the value of the exception weight of a particular resource increases, the probability that the dynamic request distributor 150 will route a new request to that particular resource decreases according to a relationship specified by an authority, e.g., a computer operator, a designer of the computer, or a designer of an application. The probability that dynamic request distributor 150 will route a request to a particular resource (e.g., resource 170A-C) is determined by a distribution priority. For example, if three resources are all equally desirable to route a request to, the routing probability of each would be 0.333. The distribution priority of each would be 1.0. However, if (absent any adjustments as described below) expected capacities of resources 170A-170C are as described above (100, 200, and 300 requests per second), distribution priorities might be set at 1, 2, and 3, respectively, resulting in routing probabilities of 0.167, 0.333, and 0.500, respectively. FIG. 3D shows a linear, monotonic, relationship, but any generally decreasing probability versus increasing exception weight is within the spirit and scope of the present invention. As shown in FIG. 3E, the resulting percentage of requests routed to the problem resource (i.e., the resource having a high exception weight) does not increase (or increase substantially, as with prior art dynamic request distributors) with increasing exception weights. In an embodiment, if an exception weight reaches an exception weight limit, the dynamic request distributor responds with a remedial action, such as, but not limited to, alerting an operator or administrator of the problem resource, powering down the problem resource, or simply not routing any requests to the problem resource for some period of time or until notified that the problem resource has been serviced. An authority such as the designer of dynamic request distributor 150, a computer operator, or a designer of an application 112 specifies the exception weight limit based on his/her requirements and/or knowledge regarding characteristics of problems in the various resources.

FIG. 3F is a bar chart showing, in general terms, how, as time passes, dynamic request distributor 150, in an embodiment, reduces requests (e.g., number of requests over a specified time period) to the problem resource. FIG. 3F shows total requests, outstanding requests, and exceptions for a particular resource. During a first period of time, T1, exceptions are relatively high compared to either total requests or outstanding requests. Responsive to the abnormally high number of exceptions, dynamic request distributor 150 routes fewer requests to the problem resource during a subsequent time period, T2. The problem resource continues to return a relatively high number of exceptions during time period T2. Responsive to the relatively high number of exceptions during time period T2, dynamic request distributor 150 again reduces the number of requests routed to the problem resource during a third time period, T3. In various embodiments, dynamic request distributor continue reducing the number of requests routed to the problem resource in subsequent time periods, alert an operator/administrator of the problem resource, or simply stop routing requests to the problem resource.

The exception weight, in an embodiment, is simply a ratio of total exceptions to total requests routed to a resource. In another embodiment, a simple exception weight would simply be the number of exceptions returned by a resource divided by the number of requests sent to the resource over a specified period of time. This simple exception weight is used both as a practical embodiment, as well as for simplicity in explanation of the concept.

Some applications 112 expect some number of exceptions as normal. For example, users making requests to internet resources (e.g., requesting web pages) request web pages that are no longer there, or the user may have mistyped the URL.

In an embodiment, a more sophisticated exception weight is utilized. Dynamic request distributor 150 normalizes an exception weight for each resource so that even though some level of exceptions occurs, resources returning an abnormally high number of exceptions are identified. For example, suppose that, during a first time period, an application 112 makes 600 requests; dynamic request distributor 150 sends 100 requests to resource 170A, 200 requests to resource 170B, and 300 requests to resource 170B. Suppose that, in response to the requests, resource 170A returns ten exceptions (10%), resource 170B returns 25 exceptions (12.5%), and resource 170C returns 90 exceptions (30%). From these exemplary results, dynamic request distributor 150 determines that a normal exception rate is approximately 10%, and that resource 170C is returning three times that rate of exceptions. In various embodiments, dynamic request distributor 150 reduces the number or requests routed to resource 170C, for example such as sending resource 170C one third as many requests in a second time period as were sent to resource 170C during the first time period. If the exception weight exceeds a an exception weight limit specified by an authority, such as an operator, a system administrator, or even a designer of a particular application 112, no further requests are routed to resource 170C, at least for a particular period of time, or upon notification that a repair action has been completed.

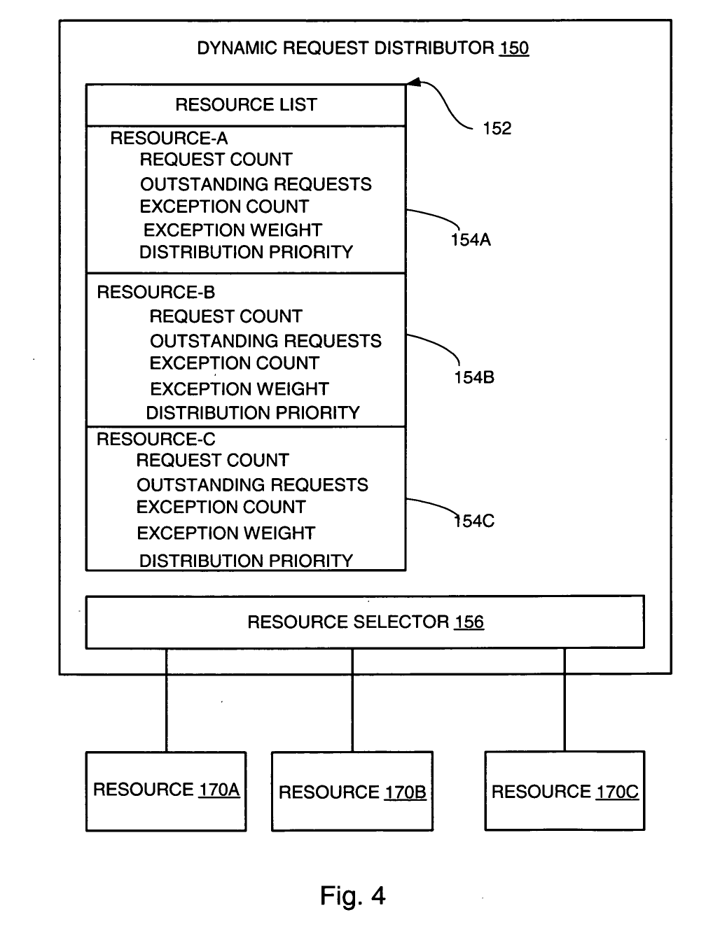

FIG. 4 shows a more detailed block diagram of dynamic request distributor 150. A resource list 152 is maintained by dynamic request distributor 150. In an embodiment, resource list 152 keeps, for each resource, a resource specific data including: a count of total requests sent to each resource over a specified time interval; a count of outstanding requests; a count of exceptions that have occurred over a specified period of time; an exception weight; and a distribution priority. Resource-A 154A holds the resource specific data for resource 170A. Similarly, resource-B 154B and resource-C 154C, respectively, hold the resource specific data for resources 170B and 170C.

In an embodiment, during the specified time interval, an exception count for the particular resource in resource list 152 is incremented each time that particular resource returns an exception. At the end of that specified time interval, an exception weight can be determined for each resource. Various methods for determining the exception weight can be used.

For example, in a first embodiment of determining the exception weight, a total request count is calculated, which is the sum of all request counts in resource list 152 (in the present example, total request count=request count of resource-A 154A+request count of resource-B 154B+request count of resource-C 154C). Likewise, a total exception count is calculated by adding up the exception counts of all resources in resource list 152. Dividing the total exception count by the total request count gives the percentage of requests during the specified time interval that resulted in exceptions, which is an overall exception weight. Then, for each resource in the resource list, the exception count for each instant resource is divided by the request count for that instant resource, giving the percentage of requests to that resource that returned an exception, and this percentage (fraction, ratio, etc) is stored as the exception weight for the instant resource. Dynamic request distributor 150 then compares the exception weight for each resource with the overall exception weight, and updates the distribution priority of each resource as specified by a designer of the computer, the designer of the application, or other authority. For example, in an embodiment, if the exception weight of a particular resource exceeds the overall exception rate by more than an amount specified by the authority, the distribution priority for that particular resource is decremented by one.

In a second embodiment of determining the exception weight, again using the resource list 152 shown in FIG. 4, an exception count for each resource in resource list 152 over a specified time period is made, as in the first embodiment of determining the exception weight, again, providing a rate of exceptions. A number of outstanding requests are kept for each resource in resource list 152. Exception weight for each resource in resource list 152 is computed as a ratio of exception counts to the number our outstanding requests. In a system having a conventional dynamic request distributor, requests might be routed to resources having a short input queue (number of outstanding requests), but if the resource returns a large number of exceptions, it is likely having problems. The authority specifies how the distribution priority varies with exception weight. Thus, dynamic request distributor 150 is able to adjust the distribution priority for each resource, and to control how many, or how few, requests are routed to a problem resource, depending upon how abnormal the exception rate is for that resource. For example, the authority, in an embodiment, specifies a relationship as shown in Table 1 below.

TABLE 1

| Exception Weight | Distr. Priority |
|---|---|
| <=5 | 10 |
| Between 5 and 10 | 5 |
| 10 or larger | 1 |

It will be understood that the values, as well as the type of definition (table versus equation, for example) are exemplary only, and that other embodiments of the invention include any way of specifying by the authority, how to determine a distribution priority from an exception weight.

Dynamic request distributor 150 further includes a resource selector 156 that determines which resource will receive an instant request, using, at least in part, the distribution priorities of the resources in resource list 152. Resource selector 156 will send more requests to a resource having a higher distribution priority than to a resource having a lower distribution priority. This avoids the “storm drain” problem should resource 170A, 170B, or 170C develop a problem that causes an abnormal number of exceptions to be returned to the requestor.

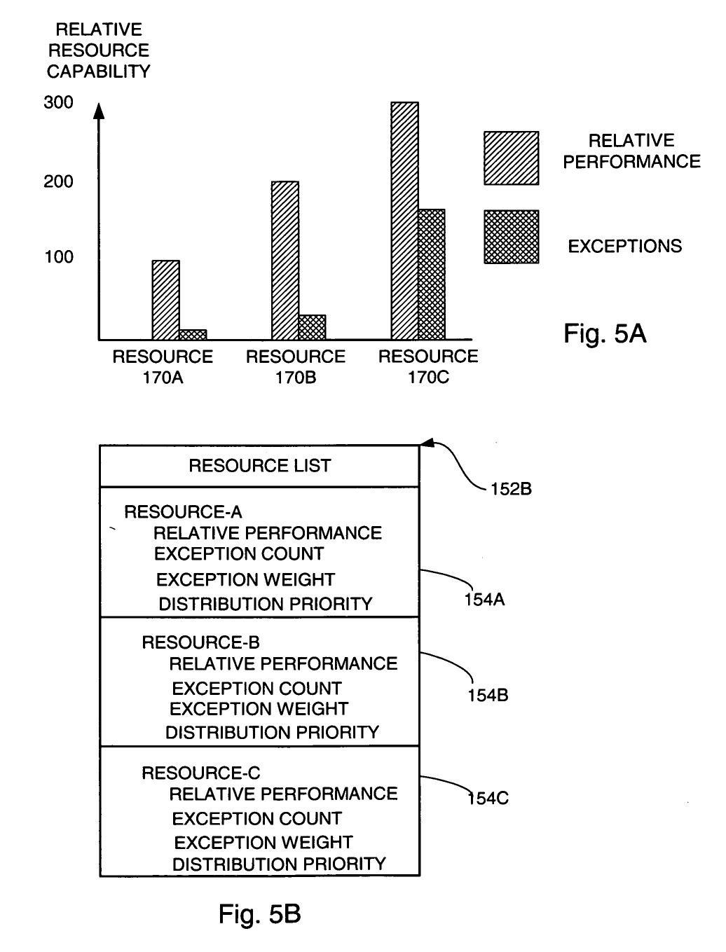

FIG. 5A, 5B show an alternative embodiment of resource list 152, reference numbered 152B to distinguish this embodiment from resource list 152 of FIG. 4, used to determine a distribution priority for each resource in resource list 152 based upon a priori knowledge of resource performance. For example, computer systems are often rated according to frequency (such as megahertz or gigahertz), TPC-C (The TPC-C benchmark yields transactions per minutes expressed in tpmC ratings), or other characteristic of the computer system. FIG. 5A shows a bar chart of relative performance of resources 170A, 170B, and 170C consistent with the capabilities described earlier (i.e., 100, 200, and 300 in relative performance). Exception counts are generated as described earlier, and stored in resource specific data 154A, 154B, 154C of resource list 152B. Resource list 152B includes a relative performance for each resource in resource list 152B, the relative performance for each resource specified by the authority (e.g., the operator of the computer, the designer of the particular application 112, etc). As shown for exemplary purposes, the exception count is about 10% of the relative performance value for resources 170A and 170B. The exception count is about 60% of the relative performance value for resource 170C. Dynamic request distributor 150 uses the ratio of exception count to the relative performance as the exception weight for each resource. As before, based on information specified by the authority, a distribution priority is determined for each resource.

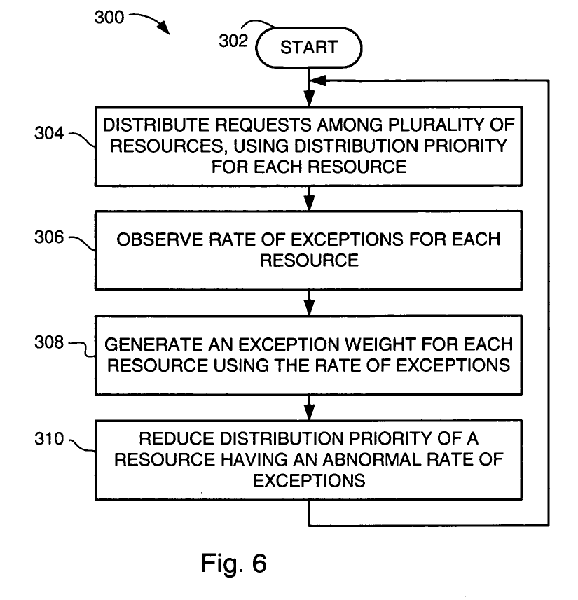

Embodiments of the invention can also be expressed as a method. FIG. 6 is a flowchart illustrating an exemplary method 300 embodiment of the invention.

Method 300 begins with step 302. In step 304, a dynamic request distributor distributes requests among a plurality of resources, using a distribution priority for each resource.

In step 306, the dynamic request distributor observes a rate of exceptions for each resource in the plurality of resources. A rate of exceptions for a particular resource is a count of how many exceptions were returned to the requestor over a specified time period. The time period is specified by the designer of the dynamic request distributor, or may be programmable by an operator or administrator of a system containing the dynamic request distributor. In an embodiment, the time period is automatically controlled by the dynamic request distributor responsive to how rapidly exceptions are occurring in one or more resources in the plurality of resources.

In step 308, the dynamic request distributor generates an exception weight for each resource. In a first embodiment, the exception weight for a particular resource is generated by calculating a ratio of exceptions per request for the particular resource to the total number of requests sent to that particular resource. In a second embodiment, the exception weight for a particular resource is generated by calculating a ratio of exceptions per request for the particular resource to a known performance characteristic of the particular resource, e.g., millions of instructions per second, TPC-C rating, and so on. In a third embodiment, the exception weight is a ratio of an exception rate to a performance characteristic (million instructions per second, TPC-C, etc) of a resource. The present invention contemplates any measurement that indicates that a particular resource is generating an abnormal number of exceptions.

In step 310 the dynamic request distributor reduces the distribution priority of a particular resource if that particular resource has an exception weight that is abnormally high as specified by an authority such as a computer operator or computer administrator, a designer of the dynamic request distributor, or the designer of an application. Alternatively the dynamic request distributor may reduce the distribution priority of the particular resource if that particular resource has an exception weight that is abnormally high compared to other resources. Control passes back to step 304.

Embodiments of method 300 can be distributed on tangible computer readable media, including, but not limited to, magnetic tapes, floppy disks, CDROMs, DVD disks, local area networks (LANs), wide area networks (WANs), and the internet.

What is claimed is:

1. An apparatus comprising:
a requestor that generates requests;
a plurality of resources, each resource capable of responding to the requests generated by the requestor, responses to a request including returning information satisfying the request, or an exception; and
a dynamic request distributor that routes each request in the plurality of requests to one of the resources in the plurality of resources;
wherein the dynamic request distributor uses an exception rate of a particular resource to reduce a likelihood of routing a future request to the particular resource if the exception rate of the particular resource is abnormally high.

2. The apparatus of claim 1, wherein the dynamic request distributor determines if the exception rate of the particular resource is abnormally high by comparing the exception rate of the particular resource to a relationship specified by an authority.

3. The apparatus of claim 2, wherein the dynamic request distributor reduces the likelihood of routing the future request to the particular resource by an amount dependent on an amount of difference between the exception rate of the particular resource and the expected exception rate according to a relationship specified by the authority.

4. The apparatus of claim 1, wherein the dynamic request distributor compares the exception rate of the particular resource with the exception rate of at least one other resource in the plurality of resources; if the exception rate of the particular resource is abnormal, the dynamic request distributor reduces the likelihood of routing the future request to the particular resource.

5. The apparatus of claim 4, wherein the dynamic request distributor reduces the likelihood of routing the future request to the particular resource by an amount dependent on how abnormal the exception rate is.

6. The apparatus of claim 1, wherein the dynamic request distributor compares the exception rate of the particular resource with an average exception rate of all resources in the plurality of resources; if the exception rate of the particular resource is abnormal, the dynamic request distributor reduces the likelihood of routing the future request to the particular resource.

7. The apparatus of claim 1, the dynamic request distributor further comprising:
a resource list to hold information about each resource in the plurality of resources.

8. The apparatus of claim 7, the resource list including, for each resource in the plurality of resources:
an exception count for storing exception rate information;
an exception weight for storing information about how significant a value in the exception count is; and
a distribution priority that contains a value determined at least in part from the exception weight.

9. The apparatus of claim 8, the dynamic request distributor further comprising a resource selector that routes requests according to the distribution priority.

10. The apparatus of claim 7, the resource list including, for each resource in the plurality of resources:
a relative performance specified by an authority;
an exception count for storing exception rate information;
an exception weight for storing information about how significant a value of the exception count is relative to the relative performance; and
a distribution priority determined, at least in part, by the exception weight.

11. A method of dynamically distributing requests from a requestor to resources capable of handling the requests, comprising the steps of:
observing a rate of exceptions returned from a particular resource responsive to requests routed to the particular resource; identifying the particular resource as a problem resource if the rate of exceptions is abnormal; and
routing fewer requests to the problem resource.

12. The method of claim 11, the step of identifying the particular resource as the problem resource including the steps of:
comparing the rate of exceptions from the particular resource to a number of requests routed to the particular resource;
comparing the rate of exceptions from the particular resource to the number of requests routed to the particular resource; and
if the comparison of the exceptions from the particular resource to the number of requests routed to the particular resource is abnormal, identifying the particular resource as the problem resource.

13. The method of claim 11, the step of identifying the particular resource as the problem resource further comprises the steps of:
observing an overall exception rate by dividing a total number of exceptions returned by all resources by a length of a time interval;
determining an overall exception weight by dividing the overall exception rate by a total number of requests made during the time interval;
determining an exception weight for the particular resource by dividing the rate of exceptions returned from the resource by the number of requests routed to the resource over a time interval used to calculate the rate of exceptions returned from the resource;
comparing the exception rate for the particular resource with the overall exception weight; and
responsive to the comparison of the exception weight for the particular resource with the overall exception weight, identifying the particular resource as the problem resource if the exception weight is abnormal.

14. The method of claim 13, further comprising the step of specifying, by an authority, how much the exception weight for the particular resource must differ from the overall exception weight to be abnormal.

15. The method of claim 11, further comprising the steps of:
receiving a relative performance for the particular resource from an authority;
comparing the rate of exceptions returned from the particular resource to the relative performance;
if the rate of exceptions returned from the particular resource is abnormally high compared to the relative performance for the particular resource, as specified by the authority, identifying the particular resource as the problem resource.

16. A program product comprising:
a tangible, computer-readable media having computer-executable instructions that, when executed on a suitable computer, perform the steps of:
observing a rate of exceptions returned from a particular resource responsive to requests routed to the resource;
identifying the particular resource as a problem resource using the rate of exceptions returned from the particular resource; and
routing fewer requests to the problem resource.

17. The program product of claim 16, the tangible, computer-readable media being one or more of the items selected from the group consisting of floppy disk, hard disk, CDROM, DVD disk, local area network, wide area network, and the internet.
